(19) United States
(12) Patent Application Publication
(10) Pub. No.: US 2008/0092107 A1
(43) Pub. Date: Apr. 17, 2008

(54) Software Development and Sales Life-Cycle Services

(76) Inventors: Joshua McWilliam, New York, NY (US); William Phelan, Loudonville, NY (US)

Correspondence Address: FENWICK & WEST LLP, SILICON VALLEY CENTER, 801 CALIFORNIA STREET, MOUNTAIN VIEW, CA, 94041, US

(21) Appl. No.: 11/863,238

(22) Filed: Sep. 27, 2007

Related U.S. Application Data
(60) Provisional application No. 60/827,203, filed on Sep. 27, 2006.

(51) Int. Cl. G06F 9/44

(52) U.S. Cl. 717/101

(57) ABSTRACT

Software developers compete with larger software publishers using a system and method for certifying, protecting, licensing, packaging, distributing, promoting, monetizing, and supporting software applications. A certification module determines compliance with mandatory criteria. A protection module enables the developer to specify portions of the application subject to protection against malfeasance. A licensing module includes a selection of licenses from which the developer can choose. A packaging module is used by the developer to make flexible combinations of different licenses into a saleable unit. Using a distribution module, the developer can then distribute the software application, updates and patches to end users. A promotion module makes products available in online catalogues for end users. A monetization module allows end users to purchase the applications, issuing activation keys and enabling payment. A management module enables end users to manage purchases and licenses. A support module lets end uses submit feedback and support requests.

### CROSS-REFERENCE TO RELATED APPLICATIONS

This application claims the benefit of U.S. Provisional Application Ser. No. 60/827,203, filed on Sep. 27, 2006 and incorporated by reference herein in its entirety.

### BACKGROUND OF THE INVENTION

1. Field of the Invention

The present invention relates generally to software development tools. In particular, the present invention is directed to systems and methods for providing software development and sales life-cycle services to software developers.

2. Description of Background Art

An ever growing number of things in our world are controlled and managed by software. The demand for innovative software applications is ever increasing as a result, as is the supply of talented engineers worldwide able to develop those innovated software applications. Additionally, there is a rapidly expanding range of development tools and open source software, both of which help to decrease the time and investment needed to develop an application. The growing demand for software coupled with the decreasing cost to produce it has and will continue to create an explosion of software applications available for consumers in all verticals.

While this exponential increase in the quantity of software has occurred, a collection of software code does not a software solution make. There are many parts of the software development life cycle (SDLC) that are critical to making a high quality software solution that meets the needs of its consumers. There have been many advances in the technology and talented resources available in other areas of the SDLC including the analysis, definition, quality assurance (QA), release & hosting, sales & licensing, marketing and support phases. While not quite as dramatic as the development phase of the SDLC, these areas have experienced substantial growth as well, creating industries with numerous companies focused on fulfilling needs in each phase. This has forced both individual companies and people to focus on creating expertise in a particular phase of the SDLC in order to compete. While this growth and focus has created efficiency gains in each respective step in the process, it has also served to complicate the process for developer, service provider and consumer alike.

While the development resources available today enable for a single developer or small company the ability to create a highly functioning software application at a fraction of the time and expense it took in the past, problems still exist, some of which are compounded by the trends mentioned above.

One problem is that of keeping up with the constantly growing number of development tools, resources and technology, which forces a developer to focus more time on development, leaving less time to become proficient in other areas of the SDLC.

Further, with the growing number of technology and service provider (QA, hosting, support, etc.) options available to assist a developer with the various phases of the SDLC grow, it becomes more complicated and time consuming to make the right decision regarding the best technologies and service provider partners to work with.

While a developer can create an application, if it is successfully, the developer may not have the resources or the knowledge to support it properly. This problem escalates as an application becomes more and more popular and a developer is forced to try and support more customers than the developer can handle. Beyond just support, developers can face the same challenges regarding the processing of new requirements and enhancement requests from their many customers.

And while a developer could create an excellent application, if no consumers know about it or have access to it, there is no way for a developer to make the money needed to maintain and continue to invest in the application. This often puts too much power in the hands of software marketers, retailers and distributors, forcing a developer to pay unfair prices to get their application to market.

The number of places to distribute an application can be numerous but are often hard to find, integrate with and manage. Furthermore, there are many retailing outlets and distribution channels that exclude all the but top software developers or create non cost-effective barriers to entry for a smaller developer beyond just integration and management costs such as sign up and minimum monthly fees or sales volume requirements.

Software piracy is also a large issue, but code protection and licensing terms are often hard to understand or not cost effective to implement. Many systems require pre-compile changes to the code and/or the creation of different distributables for different product tiers (basic, premium, enterprise, etc.). Many of these licensing solutions are limited in the types of licenses available and few offer integrated billing support.

Licensing and packaging options often must be integrated and/or configured by a developer rather than allowing a product, sales, marketing or business development person to configure licenses, packages and bundles of packages both cross product and cross vendor in order to meet customer needs, develop partnerships and maximize sales.

Creating the infrastructure needed to effectively protect, license, market, sell, bill, distribute, support and manage feedback on a product can take valuable resources away from a developer whose core competencies do not lie in those areas and could better use those resources by focusing them on development of quality applications.

In addition to the problems faced by software developers, consumers also have to address a number of issues. And, with so many options to choose from, it has become more complicated for users to determine what applications best meet their needs. Because anyone can create an application, a consumer has a harder time determining if an application meets acceptable quality standards, or even worse, determining if an application is a virus or spyware.

The user is forced sometimes to give their credit card to many different software vendor sites in order to purchase applications, enhancing the risk of that data being stolen both due to improper handling of credit card information and the amount of places it is stored.

Understanding and managing licenses can be difficult due to their complexity and non-centralized place to store them.

Software that may meet the functional needs of a consumer may not be priced in a way that meets their budget or purchasing constraints.

Getting support from a software vendor can be difficult, and in some cases impossible. Support options are often hard to find and understand due to different interfaces for each vendor, and response times can often be slow. The cost of the time wasted trying to obtain support for an issue can sometimes be worth more than the cost of the application itself.

### SUMMARY OF THE INVENTION

The present invention enables software developers to compete with larger software publishers by providing a system and method for certifying, protecting, licensing, packaging, distributing, promoting, monetizing, and supporting software applications.

In one embodiment, a software developer provides a software application to a software development and sales life cycle system. A certification module evaluates the submitted application to determine whether it complies with predefined mandatory criteria for an application of that type. Based on the application's compliance and quality, the certification module assigns a score and certification level to the software application. The developer may then publish the score for others to see, or may alter the application and resubmit it in an attempt to gain a higher score.

A protection module of the system enables the developer to specify portions of the application that are to be subject to protection against hacking, tampering, reverse engineering, decompiling, disassembling and the like. The developer can choose to have the entire module protected, if desired, or to make choices at a more granular level.

A licensing module of the system includes a selection of licenses from which the developer can choose. The selected license is then associated with the application. This allows the developer to protect his intellectual property in the software in the manner he prefers, and to assign different rights to different packages depending on distribution channel.

A packaging module is used by the developer to make flexible combinations of different licenses into a single saleable unit.

Using a distribution module, the developer can then distribute the software application, as well as updates and patches, to end users. A promotion module makes products available in online catalogues so that they can be obtained by end users once a distribution mechanism has been established.

A monetization module allows end users to purchase the applications, issuing activation keys and providing flexible billing tools to enable the developer to receive payment for the billing options chosen during the packaging configuration.

A management module enables end users to manage purchases and licenses, for example through a web site.

A support module lets end uses submit feedback and support requests to the developer via the system.

Together, the modules provide a “one stop shop” for the software development life cycle post development.

### BRIEF DESCRIPTION OF THE DRAWINGS

FIG. 1 is a block diagram of a system for providing software development and sales life-cycle services in accordance with an embodiment of the present invention.

FIG. 2 is a flow chart illustrating a method for providing software development and sales life-cycle services in accordance with an embodiment of the present invention.

### DETAILED DESCRIPTION OF THE PREFERRED EMBODIMENTS

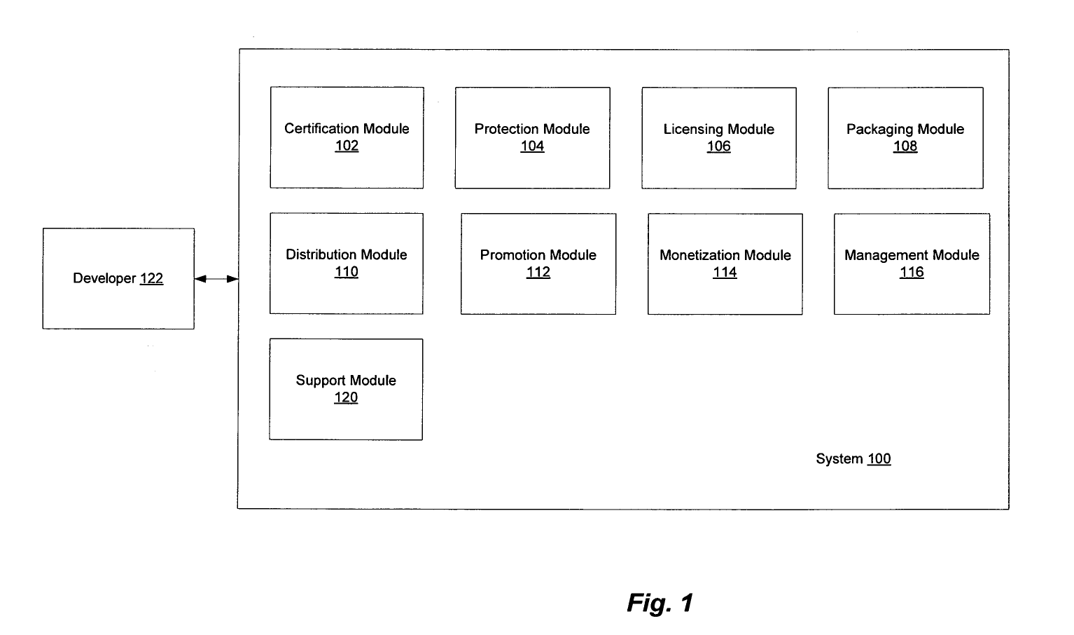

FIG. 1 illustrates a system 100 for providing software development and sales life-cycle services in accordance with an embodiment of the present invention. System 100 includes a certification module 102, protection module 104, licensing module 106, packaging module 108, distribution module 110, promotion module 112, monetization module 114, management module 16 and support module 120. Each of these modules is described further below. FIG. 1 also illustrates a software developer 122, who develops software and provides it to system 100 for testing and distribution as described herein.

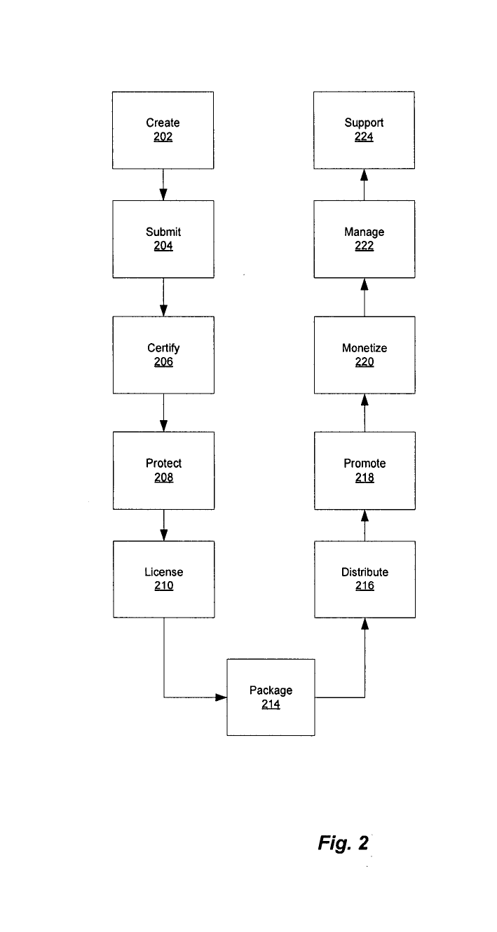

FIG. 2 is a flow chart illustrating a method for providing software development and sales life-cycle services in accordance with an embodiment of the present invention.

Initially, a software developer 122 creates 202 a software application. The developer 122 then submits 204 the application to system 100. The developer 122 may upload the application to system 100, or in an alternative embodiment may provide a link to the application in order for system 100 to retrieve the application at an appropriate time. Alternatively, the application may be provided to system 100 by way of CD-ROM, DVD, or other physical media.

Once the application has been submitted, it is ready to be certified.

Certification

Once the software application has been submitted to system 100, the developer 122 can select a certification option to have system 100 certify 206 that the software meets certain quality standards.

Certification provides a mechanism for different software applications created by different developers to be evaluated by a single system, thus providing a common set of best practices to be adopted by various developers. This review process tests the software for certain quality metrics as described below and then publishes the results of the testing.

Certification module 102 in one embodiment provides an automated certification process. One type of certification is functional certification. Functional certification includes testing for common attributes or functionality based on the type of software, as well as identifying potential bugs or defects in the software. Tests can be performed against multiple environments, including varying operating systems, web servers, databases, code frameworks, browsers and host applications.

Another certification test is a security certification, which tests for known security vulnerabilities.

Certification module 102 can also perform performance certification. Performance certification testing includes performing load testing, stress testing and capacity testing. Load testing enables measurement of response times, throughput rates, and resource utilization levels, and allows a breaking point to be determined. Stress testing evaluates the application's behavior when it is pushed beyond normal or peak load conditions. Capacity testing is complementary to load testing and determines the server's ultimate failure point, whereas load testing monitors results at various levels of load and traffic patterns. Capacity testing is therefore useful in conjunction with capacity planning.

Another certification test is usability. Usability certification testing includes adherence to accessibility and localization standards, and may also verify usage of approved user interface control/component libraries.

Usability is a quality attribute that describes how easy an application is to use, based on its usage of different interfaces. It involves user interface design, expected actions of the application, and information architecture. The end goal of usability is to improve the overall experience level of an application by providing a user with a product that is usable, useful, desirable, accessible, and valuable.

Users of applications have become accustomed to using applications or websites that act similarly. For example, when a word on a web page is underlined and colored blue, a user expects it to be is a link to a different page. By comparing all elements within a reviewed application with world-wide standard and other application-specific elements, compliance module 102 identifies issues and proposes solutions. For other application-specific elements, or elements that global standards do not exist for or apply to, compliance module 102 evaluates whether they appear the same throughout the application to avoid user confusion, and whether they are properly defined for the user.

By using basic rules, for example those defined by Section 508 of the U.S. Rehabilitation Act, potential accessibility problems with an application are identified. Certification module 102 tests an application by only using a keyboard, checking images for alternate text or descriptions, examining the use of text and background colors, and the like. Any large issues found during this process are reported.

To know exactly how a user will use an application is nearly impossible. For that reason, it is helpful to build an application that includes elements that may suit infrequent users and heavy users concurrently. During a review, any visual elements of the application that a user changes with usage are examined. Typically this involves listings of items, search options for the included content, and proper navigation techniques allowing easy and quick movement within an application. Potential issues with heavy usage are found and solutions are offered.

Worldwide use of an application is expected. An application and its tools, labels, help, or other content should be easily translatable into all languages and cultures. This requires using understandable and to-the-point content. Throughout a review words and sentences which are unusual, too long, or formatted incorrectly are reported and replacement content is recommended. This is also extended out to the application's colors, styles, and patterns, which may need customization. Any important graphical elements are also reviewed and if the elements are not editable, the issue is reported.

Usability testing includes examining the workflow and its level of efficiency around likely tasks a user will perform. The steps in a task or process should logically follow one another and not surprise or confuse a user. Smaller tasks will involve few steps and be quickly completed, and larger tasks be split up into multiple steps with the duration (field or page numbers) known to the user before and during the task. Applying these expectations to the application, issues are found and reported. It is often the case that applications do not guide a user through actions and tasks, and instead only offer settings pages. As the number of settings pages increases, as with more advanced applications, the use of guides and wizards becomes more important.

Errors made by users may lead a user to believe an application is not satisfactory when in reality, the application behaved as it was programmed to behave. While human error can always be expected, applications can be developed in ways that prevent users from making costly errors. Solutions to this problem include various procedures such as displaying common mistakes, not allowing a user to input error-causing data, and sufficient warning messages before a user saves data. During an application usability review any possible errors are noted and reported. The ease of fixing committed errors is also reported, with unfixable errors receiving a high priority status.

Code certification includes testing adherence to coding conventions, naming standards and general code best practices. Code certification in one embodiment also includes checking for viruses.

In one embodiment, certification module 102 uses code analysis tools that check .NET-managed code assemblies for conformance to the Microsoft .NET Framework Design Guidelines. Certification module 102 uses reflection, MSIL parsing, and call graph analysis to inspect assemblies for defects in the following areas of library design; localization; naming conventions; performance; and security. In addition, other custom rules and allowed exclusions can be provided to certification module 102 for testing.

In one embodiment, certification module 102 performs each of the certification testing steps. In an alternative embodiment, testing may be distributed among multiple certification modules, divided either logically or physically. For example, a number of specialized testing facilities may be incorporated to provide testing for different certification components.

Certification module 102 determines how to test each piece of software based on the type of software that is submitted, and can occur either manually or automatically, or a combination of both.

Many software applications have key indicators that signal they are a certain type of application. This may be, for example, a custom file or setting. Certification module 102 searches for known indicators to determine software type automatically. Alternatively, the developer 122 can provide a test manifest file that is readable by certification module 102 to determine in detail the parts of the software that require testing. In one embodiment, the test manifest file is a formatted XML file that includes all relevant application file information and testing information to be provided to certification module 102.

The developer 122 can also request, or system 100 may opt for a manual certification analysis.

In one embodiment, once certification module 102 completes the indicated tests, it determines a certification level for the software according to how many of the requirements were satisfied. For example, certification levels of gold, silver or bronze may be assigned according to the levels of quality and mandatory requirements satisfied.

Certification module 102 in one embodiment also performs non-mandatory tests, the results of which can be reported for informational purposes to the developer 122 or others. These tests are useful for certifying a module's attributes, as opposed to its quality. The inclusion of specified attributes in a piece of software can be communicated to a potential end-user to allow an informed decision about using that software.

Upon completion of the review certification module 102 digitally signs the software and a report including the results of the review and returns both to the developer 122. The developer can then either publish the results of the automated review, or can make modifications to the software for resubmission in order to get a higher score. In one embodiment, the developer can submit a dispute request to system 100 to have a customer service representative evaluate any difficulties with the automated results. Also in one embodiment the developer 122 can ask for a waiver from complying with one or more of the required tests, for example if they do not apply to the developer's software.

The report provided by certification module 102 in one embodiment includes a numerical result indicative of quality, and allows for comparison of the quality of different products. In one embodiment the numerical score is determined according to the number of tests passed, number of tests failed, performance relative to other applications of the same type, number and severity of errors report, and consistency of quality over time, i.e. an established history of quality. Each factor may be weighted, for example according to the importance of a test passed or failed.

The results of the review by certification module 102 are then assigned to the software and made available for later publishing and distribution with the digital commerce package, as described below.

In one embodiment, the developer 122 can submit software for additional certification. The developer 122 can select from a list containing different types of testing such as functional, security, performance, usability and coding tests. The developer 122 can also choose from varying testing detail levels as well as testing packages.

The developer 122 can then choose from a list of testing service providers to perform the advanced manual review. This list contains detailed information about each testing service provider, as well as a history of work and feedback from prior customers. Certain statistical information such as a feedback score, number of bugs found (or not found) is provided to assist the developer 122 in choosing a testing service provider.

Certification module 102 in one embodiment uses a secure, automated method to transfer software to selected testing services providers, as well as to accept testing results back into system 100. In one embodiment, testing services providers are audited periodically to ensure that they comply with advertised standards.

Code Protection

Following the certification 206 process, system 100 provides a code protection service 208. Note that in one embodiment, the services offered by system 100 can be used in a pick-and-choose fashion, i.e. a developer does not necessarily have to obtain code certification from system 100 in order to use its code protection service.

Protected code prevents code from hacking, tampering, reverse engineering, decompiling and disassembling. All software interfaces and functionality remain unchanged in protected code, allowing it to operate as normal from the end user perspective.

The developer 122 submits the software to system 100 if it has not previously been submitted. After submission, the developer 122 specifies which portions of the software should be digitally protected using protection module 104.

The developer 122 can elect to have thee entire module protected by default, or decide to go to the granularity of protecting individual methods or objects. Protection module 104 inspects the code to identify all of the methods and objects of the code. The developer 122 is then provided a tree-view type interface that allows the developer 122 to select an assembly (DLL), and then drill down into the methods and objects of that assembly. Each part in the tree has a checkbox for input next to it, and allows the developer 122 to select that part for code protection. It also allows the developer 122 to assign that selected part to a custom feature that can later be used in the licensing phase.

While the protection process in one embodiment is performed through a process referred to as transformation, the digital protection process can also be performed through other methods, including, but not limited to, encryption, obfuscation, and the like.

Licensing

In one embodiment, licensing module 106 of system 100 includes a selection of licenses prepared and managed by the operator of system 100 or its agent so that the developer 122 can choose a license that best fits the developer's needs. Providing the developer with a choice of multiple licenses enables protection of the intellectual property in the software and the ability to assign 210 different rights to different packages of software depending on the particular distribution channels being used.

In one embodiment, licensing module 106 allows the developer to select from a group of licenses and choose which licenses to apply.

Licenses can be locked to many different devices. Licensing options include, but are not limited to machine locking; website locking; website directory/virtual directory locking; SDL-10 USB dongle locking; and USB Flash Disk Locking.

Packaging

At step 214, Packaging module 108 allows developers to determine how his software is offered to the marketplace. Packaging module 108 enables flexible combinations of one or more licenses into a single saleable unit (SKU). It also enables developers to offer package types such as partial source and advertising-supported products.

Some additional choices include, but are not limited to:

1. A “Try before you buy” trial period usage with the time period set by the developer;

2. Sale of binary code package as a “single event”;

3. Sale of binary code package as a “single event” with a service agreement;

4. Sale of binary code package with revisions to the version of the software sold (“minor updates”) as well as no service agreement;

5. Sale of binary code package with revisions to the version of the software sold (“minor updates”) as well as a service agreement;

6. Subscription agreement that provides binary code packages as well as all major and minor updates (“Software as a Service”) without a service agreement;

7. Subscription agreement that provides binary code packages as well as all major and minor updates (“Software as a Service”) with a service agreement;

8. Sale of source code for a limited single use with no source code updates and no service agreement;

9. Sale of source code for a limited single use with no source code updates and a service agreement;

10. Sale of source code for a limited single use with source code updates and no service agreement;

11. Sale of source code for a limited single use with source code updates and a service agreement;

12. Sale of source code for unlimited use, to the extent such use is incorporated into a “system” and not offered for re-sale in a manor that makes it competitive to the original product offering, with no source code updates, and no service agreement;

13. Sale of source code for unlimited use, to the extent such use is incorporated into a “system” and not offered for re-sale in a manor that makes it competitive to the original product offering, with source code updates, and no service agreement;

14. Sale of source code for unlimited use, to the extent such use is incorporated into a “system” and not offered for re-sale in a manor that makes it competitive to the original product offering, with no source code updates, and no service agreement;

15. Sale of source code for unlimited use, to the extent such use is incorporated into a “system” and not offered for re-sale in a manor that makes it competitive to the original product offering, with source code updates, and service agreement;

16. Sale of “partial” source code for unlimited use, to the extent such use is incorporated into a “system” and not offered for re-sale in a manor that makes it competitive to the original product offering, with no source code updates, and no service agreement. Partial source code is defined as a software application where portions of the code are made available in binary form only, and portions are made available with source code;

17. Sale of “partial” source code for unlimited use, to the extent such use is incorporated into a “system” and not offered for re-sale in a manor that makes it competitive to the original product offering, with source code updates, and no service agreement;

18. Sale of “partial” source code for unlimited use, to the extent such use is incorporated into a “system” and not offered for re-sale in a manor that makes it competitive to the original product offering, with no source code updates, and no service agreement;

19. Sale of “partial” source code for unlimited use, to the extent such use is incorporated into a “system” and not offered for re-sale in a manor that makes it competitive to the original product offering, with source code updates, and service agreement;

20. The provision of any of the above by a developer to an end user that compensates the developer for such usage through a share of revenues derived from advertising based sources, such as Google Ad-sense, or MSN Ad Center—such compensation might be derived from multiple developers participating in a co-op or similar arrangement where multiple developers share the revenues via a formula approach to be determined;

21. The provision of items 1 through 19 above by a developer to an end user that compensates the developer for such usage based upon collecting data on actual usage of the software in a buyer or user's application and compensating the developer based upon such usage. The levels of pricing are determined by the developer.

The ability of a buyer to upgrade licenses, products, and maintenance agreements for items 1 through 19.

Distribution

Once the software has been appropriately packaged, either by system 100 or by an external mechanism, system 100 offers a distribution 216 option. Distribution module 110 enables distribution functionality similar to other Microsoft Windows-based applications such as Windows Update from Microsoft. Distribution module 110 allows the users to choose which vendors to receive updates from. Licensing and billing in one embodiment is tied to updates that enable a vendor to charge for an update based on a current or previous license. Distribution module 110 also provides for a multi-vendor distribution channel to hosters.

System 100 enables developers to distribute software installation packages, developer rights management tools, bug fixes, minor updates, major updates, and new products, through distribution module 110. Distribution module 110 allows for an end user to easily purchase a license to developers' software, and install it automatically. Future releases to the developers' software can be automatically delivered and installed via this module as well.

Promotion

As soon as a developer 122 marks their software package as being available for distribution, promotion module 112 initiates a promotion stage 218 by making the product available for purchase in any product cataloguess associated with system 100. The product catalog in one embodiment is available administratively to customers of the developer through a software update module (not shown) installed in the end user's host application environment.

The catalog is also available to other developers who are associated with system 100. Participating developers are encouraged to choose from other software modules and to create bundles of software among themselves for promotion to end user customers and other developers.

Monetize

Referring to step 220, developer rights are enforced based on the code protection settings described above. The end customer of a developer 122 requires a valid activation key in order to use the software package. Monetization module 114 provides a way for the end customer to purchase a valid license, as well as flexible billing tools designed to enable the developer to collect payment for the billing options chosen above during the packaging functions of the system. Multiple billing options area available in one embodiment, including all major credit cards, online payment services, as well as direct billing, to the extent the software is being sold to a hosting company or other enterprise customer.

Monetization module 114 includes a discounting and revenue sharing subsystem. The discounting subsystem allows developers to define discounts for their end users for module upgrades, as well as allow the developer to define wholesale pricing discounts to better enable selling to other developers and hosters. The revenue sharing system provides more opportunities for the operator of system 100, developers 122 and hosters to collectively monetize the software distribution channel.

Monetization module 114 thus enables hoster/enterprise level monetization options that are hard for a small vendor to reproduce on their own unless that is their target market. These alternate billing options give a small vendor the ability to more easily work/partner with larger clients with enhanced collective monetization options.

Management

Management module 116 enables a developer's end customers to manage 222 their purchases and licenses, e.g., via a web interface. Additional components may be created that integrate directly into developer's software to allow for management directly in the interface of the developer's software or host application. The features of management module 116 include, but are not limited to:

Customer subscription management and cancellation;

License management;

Purchase history;

Billing history;

View/Edit saved profile information such user information and preferred billing methods (Credit Card info, PayPal ID, etc.).

Feedback & Support

Support module 120 enables the developer's end customer to submit feedback and support 224 requests via, e.g., e-mail or a web interface, as well as via modules or controls built into the interface of the developer's software or host application. The features of the feedback and support component of the system include, but are not limited to:

An ability for developer's end customers to purchase a support agreement for a piece of software;

A centralized knowledge base that can be browsed and searched;

A common support request ticket system to obtain support for all software supported by the system;

An ability for the operator of system 100 A to provide support services.

An ability for third-party support services provider to provide support via the system 100. Support requests are intelligently routed based on software and the support agreement the developer's end customer has purchased.

Metrics such as average support resolution times will be tracked for each piece of software and each support service provider. These metrics will be made available to developers' end customers to assist in selecting software and support contracts.

An ability for developers' end users to submit enhancement requests and/or vote for previously added enhancement requests.

An ability for developers and/or developers' end users to provide feedback pertaining to the performance and quality of the developer's software and service provider.

In one embodiment, developers obtain from system 100 a software component that can be installed by end users along with the developer's software to allow automatic reporting of errors and exceptions. This tool reports back to support module 120 any errors that occur for that given module. The software in one embodiment reports errors and error statistics to both system 100 and to the developer. This will enable better tracking and resolution of errors. This will also provide a mechanism for system 100 to rescind a certification granted by certification module 102 to a piece of software if it is found that it is no longer meeting sufficient quality standards.

The present invention has been described in particular detail with respect to a limited number of embodiments. Those of skill in the art will appreciate that the invention may additionally be practiced in other embodiments. The present invention also has application beyond audio and video to the pricing of other items available on a network such as the Internet where it is desirable to set price according to demand on a fluctuating basis.

Within this written description, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of the above description present the feature of the present invention in terms of algorithms and symbolic representations of operations on information. These algorithmic descriptions and representations are the means used by those skilled in the art to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “processing” or “computing” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

We claim:

1. A system for providing software development services comprising:
a certification module adapted to determine a degree to which a software module complies with a predetermined set of compliance rules;
a protection module, coupled to the certification module, adapted to apply a protection scheme to a specified portion of the software module;
a licensing module, coupled to the protection module, adapted to receive a selection of at least one of a plurality of licensing schemes, the selected licensing scheme to be applied to a portion of the software module;
a packaging module, coupled to the licensing module, adapted to assemble a distribution package including the software module and the selected licensing schemes; and
a distribution module, coupled to the packaging module, adapted to distribute the distribution package to customers.

2. The system of claim A1 further comprising:
a promotion module, coupled to the packaging module, for promoting sale of the distribution package to customers.

3. The system of claim A1 further comprising:
a monetization module, coupled to the distribution module, for receiving payment from customers in exchange for distribution of the distribution package.

4. The system of A3 wherein the monetization module is further adapted to issue activation keys to the customers from whom payment has been received.

5. The system of claim A1 further comprising a support module, coupled to the distribution module, adapted to provide updates to the distribution package to customers.

6. The system of claim A5 wherein the support module is further adapted to received feedback from customers.

7. A method for providing software development services, the method comprising:
performing a certification analysis on a received software module, the certification analysis determining an a degree to which the software module complies with a predetermined set of compliance rules;
applying a protection scheme to at least a first portion of the software module;
applying a selected licensing scheme to at least a second portion of the software module;
assembling a distribution package including the software module and the applied licensing scheme; and
distributing the distribution package to one or more customers.

8. The method of claim 7 further comprising promoting sale of the distribution package to customers.

9. The method of claim 7 further comprising receiving payment from customers in exchange for distribution of the distribution package.

10. The method of claim 9 further comprising issuing activation keys to the customers from whom payment has been received.

11. The method of claim 7 further comprising providing updates to the distribution package to customers.

12. The method of claim 7 further comprising receiving feedback from customers.
